(19) United States
(12) Patent Application Publication
(10) Pub. No.: US 2016/0169781 A1
(43) Pub. Date: Jun. 16, 2016

(54) CELL-TRAPPING SYSTEM

(71) Applicant: HITACHI CHEMICAL COMPANY, LTD., Tokyo (JP)

(72) Inventors: Kenji TAKAI, Tokyo (JP); Katsuya ENDOU, Tokyo (JP); Takahiro SUZUKI, Tokyo (JP); Satomi YAGI, Tokyo (JP); Hideki ITAYA, Tokyo (JP)

(21) Appl. No.: 14/565,597

(22) Filed: Dec. 10, 2014

(51) Int. Cl. G01N 1/40

(52) U.S. Cl. CPC G01N 1/4077; G01N 2001/4088

(57) ABSTRACT

A cell-trapping system according to one embodiment of the present invention is a cell-trapping system which traps specific cells in blood by passing the blood from a first principal surface side of a filter with a plurality of through-holes formed across a thickness of a sheet toward a second principal surface side opposed to the first principal surface, wherein a linear velocity of the blood at a point in time when the blood passes through the filter is 1 cm/min to 40 cm/min, an aperture ratio of the filter is 3% to 10%, the plurality of through-holes disposed in the filter each have a rectangular shape or a rounded-corner rectangular shape, and a mean of minor pore diameters of the plurality of through-holes on the first principal surface side is 7.0 μm to 10.0 μm.

### TECHNICAL FIELD

The present invention relates to a cell-trapping system for scarce cells.

### BACKGROUND

The research or clinical significance of cancer cell enrichment is very large, and the enrichment of cancer cells in blood, if possible, can be applied to the diagnosis of cancer. For example, the most important factor for the prognosis and therapy of cancer is the presence or absence of metastasis of cancer cells on the first visit and at the time of treatment. In the case where the initial spread of cancer cells has reached peripheral blood, it is useful means for determining the progression of the state of cancer to detect circulating tumor cells (hereinafter, referred to as CTC). However, since blood components such as erythrocytes and leukocytes are present in predominantly large amounts in blood, the detection of a very small amount of CTC is difficult.

As a method for detecting CTC, for example, a method for efficiently detecting a small amount of CTC by using a resin filter comprising parylene has been proposed in International Publication No. WO 2010/135603. Alternatively, a method for using a filter comprising a metal instead of a resin to thereby improve the strength of the filter and separate leukocytes and cancer cells on the basis of a difference in deformability has also been proposed in Japanese Patent Application Laid-Open No. 2013-42689.

### SUMMARY

As disclosed in International Publication No. WO 2010/135603, studies to increase an aperture ratio have heretofore been made in order to more efficiently trap cells in blood. However, as a result of the studies, it has turned out that the highly selective trap of scarce cells cannot always be achieved even if the aperture ratio is increased for separation and enrichment by utilizing a difference in size and a difference in deformability between the scarce cells and leukocytes. Specifically, it has been found that a cell-trapping system for trapping cells in blood using a filter differs largely depending on conditions such as a shape of the filter for cell trap, an aperture ratio, a minor pore diameter, a major pore diameter, a filter thickness, a flow rate of blood, and a washing method.

Particularly, in the case where a subject to be trapped is cancer cells in blood, leukocytes among blood cell components are similar in size to cancer cells and therefore, have been found to be difficult to remove only by size.

The present invention has been made in light of those described above, and an object thereof is to provide a cell-trapping system capable of trapping target cells in blood with a higher probability.

In this respect, the cell-trapping system according to one embodiment of the present invention is a cell-trapping system which traps specific cells in blood by passing the blood from a first principal surface side of a filter with a plurality of through-holes formed across a thickness of a sheet toward a second principal surface side opposed to the first principal surface, wherein a linear velocity of the blood at a point in time when the blood passes through the filter is 1 cm/min to 40 cm/min, an aperture ratio of the filter is 3% to 10%, the plurality of through-holes disposed in the filter each have a rectangular shape or a rounded-corner rectangular shape, and a mean of minor pore diameters of the plurality of through-holes on the first principal surface side is 7.0 μm to 10.0 μm.

Also, according to one aspect of the cell-trapping system, a fluctuation range of the minor pore diameters of the plurality of through-holes on the first principal surface side is a mean±0.2 μm.

According to one aspect of the cell-trapping system, a mean of major pore diameters of the plurality of through-holes on the first principal surface side of the filter is 80 μm or larger.

According to one aspect of the cell-trapping system, a difference between the mean of minor pore diameters of the plurality of through-holes on the first principal surface side of the filter and a mean of minor pore diameters of the plurality of through-holes on the second principal surface side is 0.2 μm or less.

According to one aspect of the cell-trapping system, a thickness of the filter is 10 μm or larger and 20 μm or smaller.

According to one aspect of the cell-trapping system, preservation of the blood is performed using an EDTA-containing blood collection tube in a state where at least some of the cells are alive, and the blood is injected to the cell-trapping system within 24 hours after blood collection.

According to one aspect of the cell-trapping system, the mean of minor pore diameters of the plurality of through-holes on the first principal surface side of the filter is in a range of 7.6 μm to 8.4 μm.

According to one aspect of the cell-trapping system, preservation of the blood is performed using a cell preservative-containing blood collection tube in a state where the cells have been killed, and the blood is injected to the cell-trapping system within 96 hours after blood collection.

According to one aspect of the cell-trapping system, the mean of minor pore diameters of the plurality of through-holes on the first principal surface side of the filter is in a range of 8.4 μm to 9.2 μm.

According to one aspect of the cell-trapping system, an amount of the blood injected is in a range of 1 mL to 10 mL.

According to one aspect of the cell-trapping system, the cell-trapping system has a step of injecting a washing solution having a volume equal to or more than that of the injected blood after the blood injection to wash the filter.

According to one aspect of the cell-trapping system, a linear velocity at which the washing solution passes through the through-holes of the filter is in a range of 1 cm/min to 40 cm/min.

According to one aspect of the cell-trapping system, a main component of the filter is a metal.

According to one aspect of the cell-trapping system, a surface of the filter is gold, platinum, or palladium, or an alloy thereof.

According to one aspect of the cell-trapping system, the filter has any of nickel, copper, and palladium, or an alloy thereof as the main component.

According to one aspect of the cell-trapping system, a biocompatible polymer is firmly adsorbed on the filter.

According to one aspect of the cell-trapping system, an area of an effective portion of the filter is in a range of 0.1 mm² or larger and 1 mm² or smaller.

According to one aspect of the cell-trapping system, the specific cells in blood are cancer cells in blood.

### BRIEF DESCRIPTION OF THE DRAWINGS

FIG. 1 is a diagram illustrating the configuration of the cell-trapping system according to the present embodiment;

FIG. 2 is a diagram illustrating the configuration of the cell-trapping device according to the present embodiment;

FIG. 3 is a diagram illustrating the configuration of the filter according to the present embodiment;

FIG. 4 is a diagram illustrating a method for producing the filter according to the present embodiment; and

FIG. 5 is a diagram illustrating a method for producing the filter according to the present embodiment.

### DETAILED DESCRIPTION

Hereinafter, modes for carrying out the present invention will be described in detail with reference to the attached drawings. In the description of the drawings, the same symbols are used to indicate the same or similar factors, so that overlapping description is omitted.

(Cell-Trapping System)

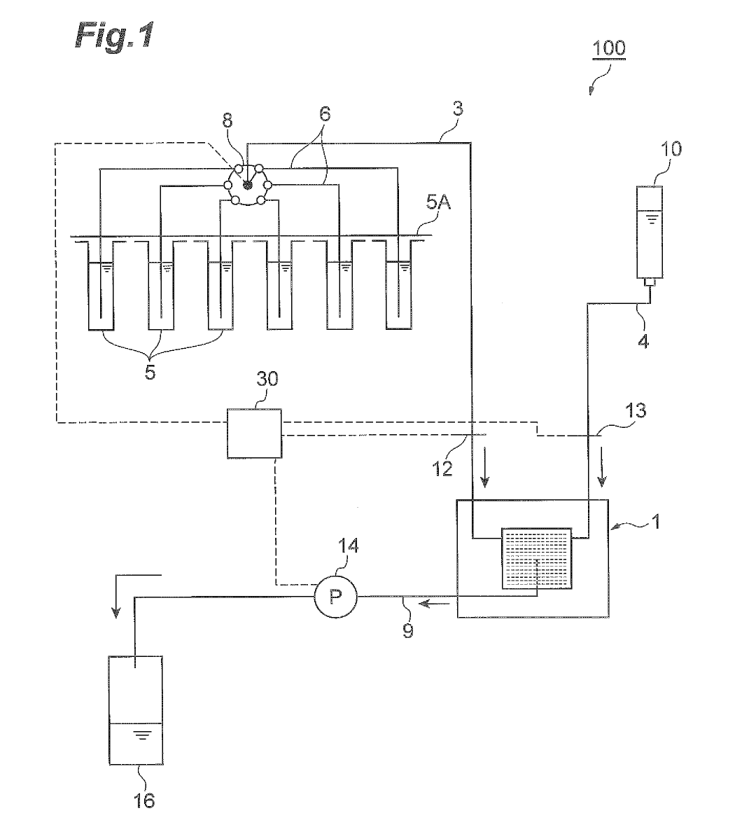

FIG. 1 is a diagram illustrating the configuration of the cell-trapping system according to the present embodiment. The cell-trapping system is an apparatus for trapping cells contained in a test solution by filtering a cell dispersion serving as the test solution through a filter. Also, cells trapped by the filter are stained using a treatment solution such as a staining solution to thereby perform the identification of the cells and the count of the population of the cells, etc. Examples of the cell dispersion serving as the test solution include blood. Furthermore, the cell-trapping system is preferably used, for example, for the purpose of trapping CTC from blood containing circulating tumor cells called CTC while passing erythrocytes, platelets, and leukocytes (hereinafter, these are collectively referred to as “blood cell components”) contained in the blood.

As shown in FIG. 1, a cell-trapping system 100 is provided with: a cell-trapping device 1 in which a filter for trapping cells is disposed in the inside; a passage 3 (treatment solution passage) composed of a soft tube for supplying a treatment solution (reagent) to the cell-trapping device 1; and a passage 4 (test solution passage) composed of a soft tube for supplying a test solution to the cell-trapping device 1. A plurality of treatment solution receptacles 5 in which different treatment solutions (reagents) are respectively contained are disposed on the upstream side of the passage 3. Examples of the treatment solutions injected in the treatment solution receptacles 5 include a staining solution for staining cells, a washing solution for washing cells, etc. trapped on the filter, a fixing solution for protecting cells from decomposition or the like, and a permeating solution for allowing the staining solution to penetrate the inside of cells.

The plurality of treatment solution receptacles 5 shown in FIG. 1 are sealed with a sealing member 5A, though this configuration is not particularly limited.

Soft tubes 6 are respectively inserted in the plurality of treatment solution receptacles 5 to form individual passages (treatment solution passages). These passages are further connected to a selection valve 8; the selection valve 8 is turned to thereby select a treatment solution to be connected to the passage 3; and the passage 3 is connected to the soft tube 6 inserted in the treatment solution receptacle 5 in which the selected treatment solution is housed.

A test solution receptacle 10 in which blood containing cells is housed as a test solution in the inside is connected to the passage 4 to be connected to the cell-trapping device 1. The configuration is made in which, to the cell-trapping device 1, the treatment solution and the test solution are not simultaneously supplied, but any one thereof is supplied. Control to supply any solution of the treatment solution and the test solution is switched by valves 12 and 13 attached to the passages 3 and 4, respectively. For example, in the case of supplying a test solution to the cell-trapping device 1, the valve 12 is closed, and the valve 13 is opened. Pinch valves that alter the shapes of the soft tubes under pressure to block the flows thereof can be used as the valves 12 and 13.

Also, in the case of supplying any solution of the treatment solution and the test solution to the cell-trapping device 1, solution supply is performed by aspirating the solution of interest by the drive of a pump 14 (supply unit) disposed on a passage 9 (passage for discharge from the system) composed of a soft tube on the downstream side of the cell-trapping device 1. The pump 14 has a structure capable of changing the flow rate of a solution in the passage by the change of the number of rotations. For example, a peristaltic pump that sequentially shifts a peristaltic point based on pressure applied to the soft tube can be used as the pump 14. By the drive of the pump 14, a solution such as a treatment solution or a test solution is flowed in the inside of the passage 3 or the passage 4 in a direction toward the cell-trapping device 1, and supplied to the cell-trapping device 1. The structure is made in which the solution that has passed through the cell-trapping device 1 is flowed into a waste container 16 through the passage 9. By these structures, the cells in the test solution are trapped by the filter disposed on the passage in the cell-trapping device 1, while the cells are stained with the staining solution.

A velocimeter may be disposed in the passage 9 on the downstream side of the cell-trapping device 1. In this case, the migration velocity of a test solution or a treatment solution flowing in the passage 9 can be measured to thereby determine the linear velocity of the test solution or the treatment solution passing through the filter in the cell-trapping device 1.

The control of each section described above is performed by a controller 30. Specifically, the drive of the selection valve 8, the valves 12 and 13, and the pump 14 is performed by a command from the controller 30. A program input function for inputting a program that enables control such as drive or halt as to each section described above is included in the controller 30, and a drive mechanism which operates each instrument in order as described above by the thereby input program is attached. A line to which the solution is flowed is selected by the controller 30, and commands for the opening or closing of the aforementioned valves and the drive of the pump from the controller 30 are executed on each section on the basis of the selection results.

Furthermore, in the case where a velocimeter is disposed in the cell-trapping system 100, the controller 30 may be configured so as to control the migration velocity of the solution in the cell-trapping system 100 on the basis of information from the velocimeter.

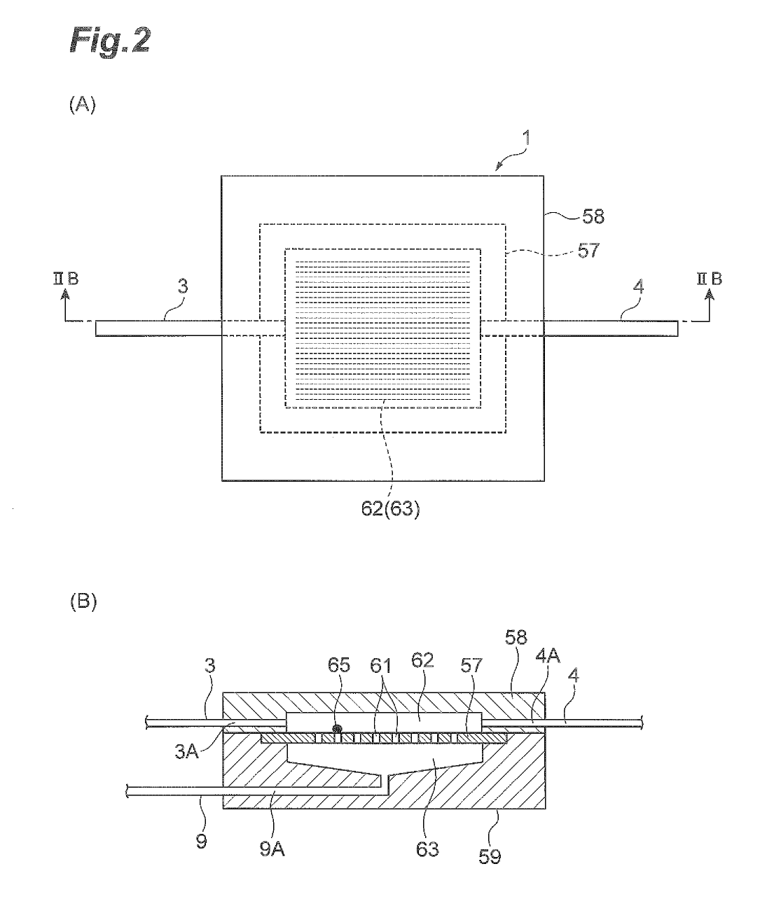

Next, the cell-trapping device 1 will be described with reference to FIG. 2. FIG. 2(A) is a top view of the cell-trapping device 1, and FIG. 2(B) is a sectional view taken along the IIB-IIB line in FIG. 2(A).

The cell-trapping device 1 is configured such that a filter 57 with a plurality of through-holes 61 formed across a thickness of a sheet is sandwiched between a lid member 58 and a housing member 59. The filter 57 is disposed in space formed in the inside when the lid member 58 and the housing member 59 are combined. The filter 57 is made of, for example, a metal, and the plurality of through-holes 61 are formed across the thickness thereof.

A passage 3A (inlet passage) which is formed of a soft tube and connected to the passage 3, and a passage 4A (inlet passage) which is connected to the passage 4 are formed in the lid member 58 of the cell-trapping device 1, while an introduction region 62 which is formed above the filter 57 so as to communicate with the passages 3A and 4A and serves as space for leading the solution to the through-holes 61 of the filter 57 is disposed. Specifically, in the present embodiment, the “inlet passages” refer to the passages 3A and 4A disposed in the inside of the cell-trapping device 1, among the passages. Also, the “treatment solution passage” and the “test solution passage” refer to the passages 3 and 4 connected to the upstream sides of the passages 3A and 4A, respectively, of the cell-trapping device 1.

A discharge region 63 which is formed below the filter 57 such that the depth of the central portion is larger than that of the periphery, and serves as space for discharging a solution that has passed through the through-holes 61 of the filter 57 to the outside is disposed in the housing member 59 of the cell-trapping device 1. A passage 9A (discharge passage) which communicates with the discharge region 63 while being connected to the passage 9 to discharge the solution of the discharge region 63 to the outside is further disposed in the housing member 59.

In the cell-trapping system 100 having the configuration described above, first, the test solution of the test solution receptacle 10 is introduced to the cell-trapping device 1 via the passage 4. In the cell-trapping device 1, the test solution is introduced from the passage 4A for a test solution, discharged from the passage 9A after passing through the filter 57 from the upper side (first principal surface side) to the lower side (second principal surface side), and sent to the waste container 16. Since cells as a trap target cannot pass through the through-holes 61 of the filter 57 at this time, a cell 65 is captured on the filter 57. The first principal surface on the upper side and the second principal surface on the lower side are opposed to each other.

Next, washing and staining for detecting the captured cells are performed. The washing and the staining are performed by supplying a washing solution, a fixing solution, a permeating solution, and a staining solution from the passage 3 of a tube that is connected to the passage 103a after the completion of filtering of the test solution using the cell-trapping device 1. By this procedure, the capturing of the cells using the filter 57 and the staining with the treatment solution are performed. Moreover, the cell-trapping device 1 is removed, if necessary, from the passages 3 and 4 and the passage 9 for the identification of the cells and the count of the number of the cells, etc.

(Filter)

Next, the filter 57 included in the cell-trapping device 1 constituting the cell-trapping system 100 will be described in detail. One as hard as possible is preferable as a material of the filter 57, and a metal is particularly desirable. Since the metal is excellent in workability, the processing accuracy of the filter can be enhanced. As a result, the rate of capturing of a component serving as a subject to be captured can be further improved. Also, since the metal is rigid compared with other materials such as plastics, its size and shape are maintained even if force is applied from the outside. Therefore, in the case of deforming and passing a component slightly larger than the through-hole, more accurate separation and enrichment become possible.

Any of nickel, silver, palladium, copper, iridium, ruthenium, and chromium, or an alloy thereof is preferable as a main component of the metal. Of these, silver (Ag), nickel (Ni), palladium (Pd), copper (Cu), or iridium (Ir) is particularly preferable because of being a material capable of electroplating.

Of these, it is particularly preferable that copper or (on the precondition that copper plating is performed) nickel should be used as a main component of the metal. Copper can be easily removed by chemical dissolution with a chemical and is also excellent in adhesion to a photoresist compared with other materials.

In this context, palladium and iridium have favorable properties of a high oxidation-reduction potential and poorly solubility, but have the disadvantage of being highly expensive. Nickel is readily dissolved because the oxidation-reduction potential is lower than that of hydrogen, but is inexpensive. Silver and palladium are noble metals and are relatively inexpensive compared with palladium and iridium.

Examples of aperture shapes of the through-holes 61 disposed in the filter 57 include circles, ellipses, squares, rectangles, rounded-corner rectangles, and polygons. A circular shape, a rectangular shape, or a rounded-corner rectangular shape is preferable from the viewpoint of being able to efficiently capture a target component. The rounded-corner rectangle is a shape composed of two long sides with equal lengths and two semicircles. By this shape, the through-holes are less likely to be clogged, and the rate of enrichment of the component serving as a subject to be captured can be further improved.

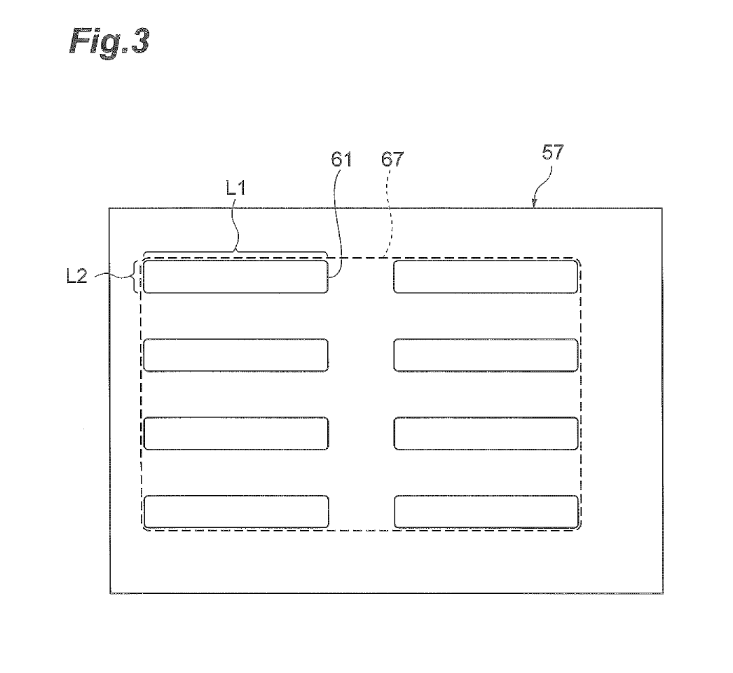

An example in which the through-holes 61 are made into a rounded-corner rectangular shape is shown in FIG. 3. As shown in FIG. 3, the maximum length on the long-side side in the through-holes 61 is defined as a major pore diameter L1, and the maximum length on the short-side side is defined as a minor pore diameter L2. A reason why such a shape is preferable is that in the case where a circular shape is clogged with cells, the pressure of the portion rises, easily resulting in a distorted shape as clogged with cells. For the rectangle or the rounded-corner rectangle, a local rise in pressure is less likely to occur, because voids are present in the majority even if some are clogged with cells.

An aperture ratio defines the ratio of a region occupied by the through-holes 61 to a region where the through-holes 61 are present. In FIG. 3, a region surrounded by a broken line 67 is the “region where the through-holes 61 are present”, and the ratio of a region occupied by the through-holes 61 to this region is therefore referred to as the “aperture ratio”. The aperture ratio of the filter 57 is preferably in a range of 1% to 30%, more preferably in a range of 3% to 10%. In the case where the aperture ratio is less than 3%, blood tends to be stuck, and in the case where the aperture ratio exceeds 10%, leukocytes increase because pressure is less likely to be applied.

The mean of the minor pore diameter L2 of the filter is preferably in a range of 7.0 μm to 10.0 μm on the upper side (introduction region side: first principal surface side). In the case where the pore diameter is shorter than 7.0 μm, leukocytes are less likely to go through it, so that the rate of enrichment of cells gets worse. In the case where the pore diameter is longer than 10.0 μm, the rate of recovery of scarce cells decreases.

The optimum value of the minor pore diameter L2 differs depending on the life or death of cells. In the case where the cells are alive, all of the cells are highly deformable and therefore, it is possible to pass through the through-holes 61 even if the minor pore diameter L2 is short. However, in the case where the cells are dead or immobilized, it is necessary to extend the minor pore diameter L2.

In the case where: an EDTA (ethylenediaminetetraacetic acid)-containing blood collection tube is used in collecting blood from an organism; preservation of the blood is performed in a state where at least some of the cells are alive; and the blood is injected to the cell-trapping system 100 within 24 hours after the blood collection, it is possible that the cells pass through the through-holes 61 even if the minor pore diameter L2 is short. In this case, favorable results are readily obtained provided that the mean of the minor pore diameter L2 on the upper side of the filter is in a range of 7.6 μm to 8.4 μm.

In this context, it is preferable to use a blood collection tube containing a fixative or a cell stabilizer, such as paraformaldehyde, from the viewpoint of long-term preservation of blood. In this case, preservation is performed in a state where the cells have been killed. As for the death of the cells according to the present invention, a state where the cells cannot grow is called death. In this case, the cells can be stably preserved for approximately 96 hours. Thus, it is preferable to inject the blood to the cell-trapping system 100 within 96 hours after the blood collection. In this case, more favorable results are readily obtained provided that the mean of the minor pore diameter L2 on the upper side of the filter is in a range of 8.4 μm to 9.2 μm.

In this context, it is desirable that the fluctuation range of the minor pore diameter L2 of the through-holes 61 on the upper side of the filter 57 should fall within a range of a mean±0.2 μm. In this range, the rate of recovery and the value of residual leukocytes are readily stabilized.

It is also desirable that the difference between the mean of the minor pore diameter L2 on the upper side of the filter 57 and the mean of the minor pore diameter on the lower side of the filter should be 0.2 μm or less. In the case where the difference between the mean of the minor pore diameter L2 on the upper side of the filter 57 and the mean of the minor pore diameter on the lower side of the filter 57 is more than 0.2 μm and the minor pore diameter L2 on the upper side is larger, cells tend to be stuck in the lower side of the filter. On the other hand, in the case where the difference between the mean of the minor pore diameter L2 on the upper side of the filter 57 and the mean of the minor pore diameter on the lower side of the filter 57 is more than 0.2 μm and the minor pore diameter on the lower side is larger, scarce cells tend to pass through the through-holes 61 of the filter 57.

It is desirable that the thickness of the filter 57 should be 10 m or larger and 20 μm or smaller. In the case where the thickness of the filter 57 is smaller than 10 μm, scarce cells tend to pass through the through-holes 61 of the filter 57, and in the case of exceeding 20 μm, cells (for example, leukocytes) other than scarce cells have difficulty in passing through the through-holes 61 of the filter 57.

The major pore diameter L1 of the filter is desirably 30 μm or larger, more desirably 50 μm or larger, further desirably 80 μm or larger, most preferably 100 μm or larger. A large number of fibrous substances such as fibrin are present in blood serving as a test solution. These fibrous substances more easily pass through the through-holes 61 of the filter 57, as the major pore diameter L1 becomes longer. In the case where the major pore diameter L1 of the filter 57 is smaller than 30 μm, residual leukocytes tend to increase because the fibrous substances have difficulty in passing through the through-holes 61 of the filter 57.

The linear velocity at a point in time when the blood passes through the holes of the filter 57 is also an important factor in the case where cells such as leukocytes in the blood pass through the filter 57. It is desirable that the linear velocity at which the blood passes through the holes of the filter 57 should be in a range of 1 cm/min to 40 cm/min. The control of the linear velocity is performed by the controller 30.

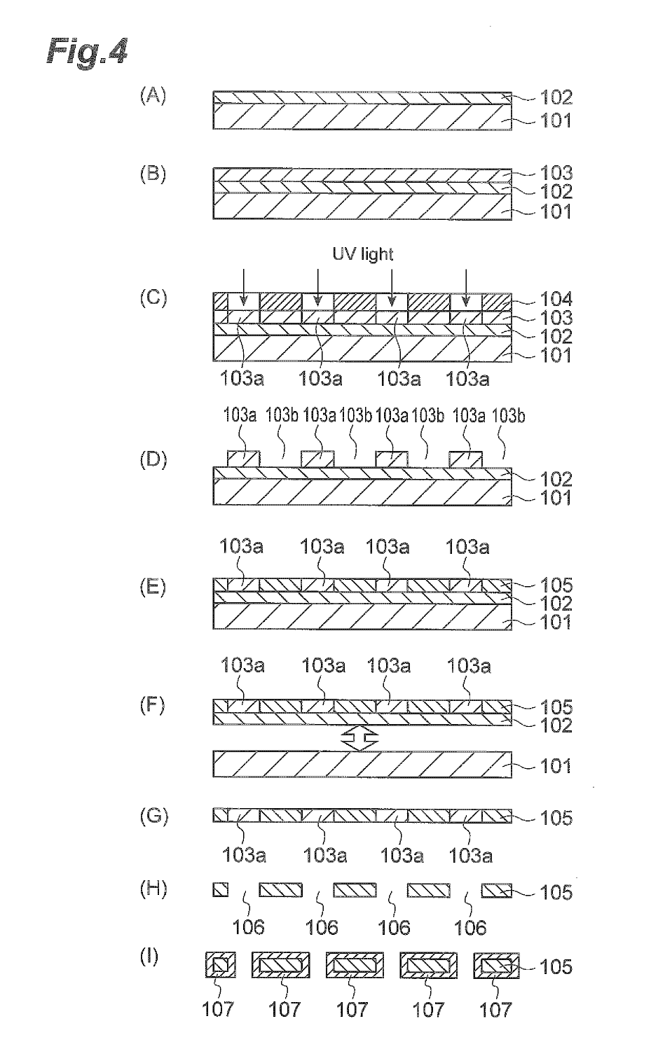

Next, a method for producing the filter will be described in detail with reference to FIGS. 4(A) to 4(I). In the description below, a method for producing a filter whose main component is a metal and whose surface is plated will be described.

FIG. 4(A) shows a state where metal foil 102 is laminated on a carrier layer 101. In a lamination step shown in FIG. 4(B), a photoresist 103 made of a photosensitive resin composition is formed on the metal foil 102. Subsequently, in a light exposure step shown in FIG. 4(C), the photoresist 103 is irradiated with active rays (UV light) through a photomask 104 so that the light-exposed portion is photo-cured to form a cured product of the photoresist. Subsequently, in a development step shown in FIG. 4(D), the photoresist 103 (portions corresponding to 103b) except for the cured product is removed to form a photoresist pattern 103a. Subsequently, in a plating step shown in FIG. 4(E), a plated layer 105 is formed on the metal foil 102 with the formed resist pattern composed of the cured product 103a. Subsequently, as shown in FIG. 4(F), the metal foil 102 and the carrier layer 101 are peeled off. Subsequently, in a dissolution step shown in FIG. 4(G), the metal foil 102 is removed by chemical dissolution. As a result, the photoresist pattern 103a composed of the cured product of the photoresist, and the plated layer 105 remain. Subsequently, in a peel-off step shown in FIG. 4(H), the resist pattern composed of the cured product 103a of the photoresist is removed, and the metal filter composed of the plated layer 105 is recovered. Through-holes 106 are provided in the filter. Finally, in a plating step shown in FIG. 4(I), a plated layer 107 is formed on the surface to obtain the filter 57.

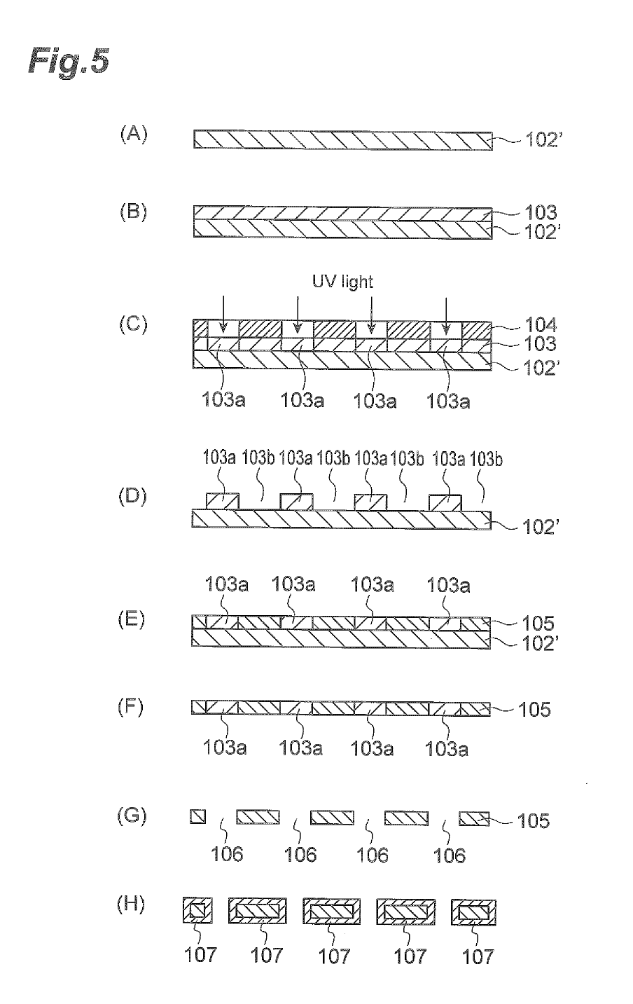

FIGS. 5(A) to 5(I) are process charts illustrating another method for producing the filter 57. The production method shown in FIG. 5 when compared with the production method shown in FIG. 4 differs in that a substrate 102′ made of a metal is used instead of the metal foil 102. In this case, the filter 57 can be produced by a method similar to the production method shown in FIG. 4 except that the step of peeling off the metal foil 102 and the carrier layer 101 shown in FIG. 4(F) is not present. However, since the substrate 402′ is thicker than the metal foil 102, the amount of the chemical dissolution agent and the time used in the process of removing the substrate 102′ by chemical dissolution in the dissolution step increase compared with the case of removing the metal foil 102.

Hereinafter, each step will be described in more detail.

(Lamination Step)

First, a state where the metal foil 102 is laminated on the carrier layer 101 is shown. Metal foil removable by etching can be used as the metal foil 102, and specifically, foil of copper, nickel, a nickel-chromium alloy, or the like is used, with copper foil being preferable. The copper foil is readily removable by chemical etching and is also excellent in adhesion to a photoresist compared with other materials. Use of one in which the metal foil 102 is bonded to the carrier layer 101 composed of a copper-clad laminate to a degree that can be peeled off in a later step is preferable because of being excellent in workability and handleability during the filter production process. Specifically, peelable copper foil (manufactured by Hitachi Chemical Co., Ltd.) can be used as the configuration as described above. The peelable copper foil is copper foil composed of at least 2 layers of an ultrathin copper foil and a carrier layer.

FIG. 4(B) is a diagram showing a state where the photoresist 103 made of a photosensitive resin composition is formed on the metal foil 102. Any of negative type and positive type may be used as the photoresist 103, with a negative-type photoresist being preferable. It is preferable that the negative-type photoresist should contain at least a binder resin, a photopolymerizable compound having an unsaturated bond, and a photopolymerization initiator. In this context, in the case of using a positive-type photoresist, in the photoresist layer, the solubility of the light-exposed portion in a developing solution is enhanced by irradiation with active rays, and the light-exposed portion is therefore removed in the development step. Hereinafter, the case using the negative-type photoresist will be described.

The thickness of the finally obtained filter 57 is equal to or smaller than the thickness of the photoresist pattern. Therefore, it is necessary to form a photoresist layer with a film thickness suitable for the thickness of the filter 57 of interest. In this context, the thickness of the photoresist is preferably 1.0 time to 2.0 times the thickness of a later conductor in consideration of peelability, etc. If this thickness is small, the resist is difficult to peel off later, and if it is large, circuit formability is difficult. Specifically, a thickness of 15 to 50 μm is preferable.

(Light Exposure Step)

Subsequently, the light exposure step will be described. The photomask 104 having a wave-shaped translucent portion is layered on the photoresist 103 on the metal foil 102 and then irradiated with active rays so that the light-exposed portion is photo-cured to form the cured product 103a of the photoresist. Next, the light exposure of the photoresist is performed with the photomask layered.

(Photoresist Pattern Formation Step)

In the photoresist 103, portions except for the cured product of the photoresist are removed from the metal foil 102 to thereby form the photoresist pattern 103a composed of the cured product of the photoresist on the metal foil 102. In the case where a support film or the photomask is present on the photoresist, the removal of the portions except for the cured product of the photoresist (development) is performed after removing the support film or the photomask. Development methods include wet development and dry development, and wet development is widely used.

In the case of the wet development, the development is performed by a development method known in the art using a developing solution appropriate for the photoresist. Examples of the development method include methods using a dip scheme, a paddle scheme, a spray scheme, brushing, slapping, scrapping, and shaking and dipping, and a high-pressure spray scheme is most suitable from the viewpoint of improvement in resolution. Of these development methods, two or more methods may be combined to perform the development.

(Metal-Plated Pattern Formation Step)

After the development step, metal plating is performed on the metal foil 102 to form the metal-plated pattern 105. Examples of methods for the plating include solder plating, nickel plating, and gold plating. Since this plated layer finally becomes a filter and the photoresist pattern is removed in the subsequent step to prepare through-holes of the filter, it is important to perform the plating lower than the height of the photoresist pattern so as not to block the photoresist pattern.

Examples of electrolytic nickel plating include a Watts bath (nickel sulfate, nickel chloride, and boric acid are main components), a sulfamic acid bath (nickel sulfamate and boric acid are main components), and a strike bath (nickel chloride and hydrogen chloride are main components).

Examples of electrolytic silver plating include baths having potassium silver cyanide or potassium tartrate as a main component.

Examples of electrolytic palladium plating include baths composed of water-soluble palladium salts and naphthalenesulfonic acid compounds.

Examples of electrolytic iridium plating include baths containing soluble iridium salts containing halogen, and alcohols.

Examples of electrolytic copper plating include baths having copper sulfate, sulfuric acid, and chloride ions as main components.

Electrolytic plating is performed using these plating baths. A current density for the electrolytic plating is preferably in a range of 0.3 to 4 A/dm², more preferably in a range of 0.5 to 0.103 A/dm². By setting the current density to 4 A/dm² or lower, the occurrence of roughness can be suppressed, and by setting the current density to 0.103 A/dm² or higher, crystalline grains of the metal grow sufficiently and effects as a barrier layer are enhanced; thus the effects of the present embodiment are readily obtained favorably.

After forming the circuit as described above, the resin layer is peeled off, and the copper foil is etched to thereby finish the filter made of the metal.

Next, the resist remaining on the filter is removed with a strong alkali. A 0.1 to 10 wt % aqueous NaOH or KOH solution is preferable as the strong alkali. Monoethanolamine (1 to 20 vol %) or the like may be added in order to promote the peel-off. In the case where the peel-off is difficult, the resist can also be removed with a solution of sodium permanganate or potassium permanganate, or the like supplemented with the alkali (0.1 to 10 wt % aqueous NaOH or KOH solution).

For the filter from which the resist has been removed, it is preferable to perform noble metal plating. Gold, palladium, platinum, ruthenium, indium, or the like is preferable for the noble metal plating.

In the noble metal plating, gold has the highest oxidation-reduction potential among all of the metals, as mentioned above, and is reportedly free from cytotoxicity. Discoloration, etc. is also rarely found in long-term preservation.

The gold plating may be performed without electrolysis or may be performed by electrolysis. The non-electrolytic execution is desirable because, in the case of the electrolytic execution, variation in thickness becomes large and tends to have influence on the pore diameter accuracy of the filter. However, the electrolytic gold plating can improve a coverage ratio.

Although the gold plating is effective by merely performing displacement plating, the combination of the displacement plating with reduction plating produces greater effects.

The filter before gold plating may have an oxidized surface. Accordingly, the removal of the oxide film is performed, and in this respect, it is preferable to perform washing with an aqueous solution containing a compound that forms a complex with a metal ion. Specifically, aqueous solutions containing cyanogens, EDTAs, or citric acids are preferable. Among them, citric acids are optimal for pretreatment of the gold plating. Specifically, anhydride of citric acid, hydrate of citric acid, citric acid salt, or hydrate of citric acid salt is acceptable, and specifically, citric acid anhydride, citric acid monohydrate, sodium citrate, potassium citrate or the like can be used. Its concentration is preferably 0.01 mol/L to 3 mol/L, more preferably 0.03 mol/L to 2 mol/L, particularly preferably in a range of 0.05 mol/L to 1 mol/L. By 0.01 mol/L or higher, the adhesion between the non-electrolytic gold-plated layer and the filter is improved. In the case of exceeding 3 mol/L, effects are not improved, and furthermore, it is not economically preferable.

It is preferable to perform filter immersion in a citric acid-containing solution at 70° C. to 50° C. for 1 to 20 minutes. Although the citric acid-containing solution may be supplemented with a reducing agent that is contained in a plating solution or the like, or a buffering agent such as a pH adjuster within a range where the effects of the invention are obtained, the addition of the reducing agent, the pH adjuster, or the like is desirably in a small amount, with an aqueous solution of only citric acid being most preferable. The pH of the citric acid-containing solution is preferably 5 to 10, more preferably 6 to 9.

Without particularly limiting the pH adjuster as long as being an acid or an alkali, hydrochloric acid, sulfuric acid, nitric acid, or the like can be used as the acid, and examples of the alkali include hydroxide solutions of alkali metals or alkaline earth metals, such as sodium hydroxide, potassium hydroxide, and sodium carbonate. As mentioned above, it can be used without inhibiting the effects of citric acid. Moreover, if nitric acid is contained at a concentration as high as 100 ml/L in the citric acid-containing solution, the effect of improving adhesion properties is reduced compared with the case of treatment with the solution containing only citric acid.

Without particularly limiting the reducing agent as long as being reductive, examples include hypophosphorous acid, formaldehyde, dimethylamine borane, and sodium borohydride.

Next, displacement gold plating is performed. The displacement gold plating includes cyanogen baths and non-cyanogen baths, and a non-cyanogen bath is desirable in light of environmental burdens and cytotoxicity of remnants. Examples of gold salts contained in the non-cyanogen bath include chloroaurate, gold sulfite, gold thiosulfate, and gold thiomalate. Only one type of the gold salts may be used, or two or more types may be used in combination.

Furthermore, since a cyanogen-based bath has too strong an effect of dissolving metals, some metals tend to be dissolved to generate pinholes. In the case of sufficiently performing the pretreatment as described above, a non-cyanogen-based plating bath is preferable.

Gold sulfite is particularly preferable as a supply source of gold. Sodium gold sulfite, potassium gold sulfite, ammonium gold sulfite, or the like is preferable as the gold sulfite.

The gold concentration is preferably in a range of 0.1 g/L to 5 g/L. At lower than 0.1 g/L, gold is less likely to deposit, and at higher than 5 g/L, the solution is easily decomposed.

An ammonium salt or an ethylenediaminetetraacetic acid salt may be contained as a gold complexing agent in the displacement gold plating bath. Examples of the ammonium salt include ammonium chloride and ammonium sulfate, and ethylenediaminetetraacetate, sodium ethylenediaminetetraacetate, potassium ethylenediaminetetraacetate, or ammonium ethylenediaminetetraacetate is used as the ethylenediaminetetraacetic acid salt. It is preferable that the concentration of the ammonium salt should be used in a range of 7×10⁻³ mol/L to 0.4 mol/L, and if the concentration of the ammonium salt falls outside this range, the solution tends to be unstable. It is preferable that the concentration of the ethylenediaminetetraacetic acid salt should be used in a range of 2×10⁻³ mol/L to 0.2 mol/L, and if the concentration of the ethylenediaminetetraacetic acid salt falls outside this range, the solution tends to be unstable.

0.1 g/L to 50 g/L of a sulfurous acid salt may be contained in order to stably maintain the plating solution. Examples of the sulfurous acid salt include sodium sulfite, potassium sulfite, and ammonium sulfite.

It is preferable to use hydrochloric acid or sulfuric acid as the pH adjuster for decreasing pH. Alternatively, it is preferable to use sodium hydroxide, potassium hydroxide, or ammonia water for increasing pH. It is preferable that the pH of the plating solution should be adjusted to 6 to 7. If the pH of the plating solution falls outside the above range, the stability of the solution and the outer appearance of plating are adversely affected.

It is preferable that the displacement plating should be used at a solution temperature of 30° C. to 80° C. If the solution temperature falls outside this range, the stability of the solution and the outer appearance of plating are adversely affected.

Although the displacement plating is performed by the method described above, it is difficult for the displacement plating to fully cover the filter. Accordingly, reduction-type gold plating containing a reducing agent is subsequently performed. The thickness of the displacement plating is preferably in a range of 0.02 μm to 0.1 μm.

Gold sulfite and thiosulfate are preferable as gold salts for the reduction-type gold plating, and it is preferable that the content thereof should be in a range of 1 g/L to 10 g/L in terms of gold. If the content of gold is lower than 1 g/L, the deposition reaction of gold is reduced, and higher than 10 g/L is not preferable because the stability of the plating solution is reduced while the amount of gold consumed is increased due to the take-out of the plating solution. It is more preferable that the content should be set to 2 g/L to 5 g/L.

Examples of the reducing agent include hypophosphorous acid, formaldehyde, dimethylamine borane, and sodium borohydride, with a phenyl compound-based reducing agent being more preferable. Examples include phenol, ortho-cresol, para-cresol, ortho-ethylphenol, para-ethylphenol, tert-butylphenol, ortho-aminophenol, para-aminophenol, hydroquinone, catechol, pyrogallol, methylhydroquinone, aniline, ortho-phenylenediamine, para-phenylenediamine, ortho-toluidine, ortho-ethylaniline, and para-ethylaniline, and one or two or more of these can be used.

It is preferable that the content of the reducing agent should be 0.5 g/L to 50 g/L. If the content of the reducing agent is lower than 0.5 g/L, a practical deposition rate tends to be difficult to obtain, and if exceeding 50 g/L, the stability of the plating solution tends to be reduced. It is more preferable that the content of the reducing agent should be 2 g/L to 10 g/L, and it is particularly desirable to be 2 g/L to 5 g/L.

The non-electrolytic gold plating solution may contain a heavy metal salt. From the viewpoint of promoting the deposition rate, it is preferable that the heavy metal salt should be at least one selected from the group consisting of thallium salts, lead salts, arsenic salts, antimony salts, tellurium salts, and bismuth salts.

Examples of the thallium salts include: inorganic compound salts such as thallium sulfate, thallium chloride, thallium oxide, and thallium nitrate; and organic complex salts such as dithallium malonate, and examples of the lead salts include: inorganic compound salts such as lead sulfate and lead nitrate; and organic acetic acid salts such as acetate.

Also, examples of the arsenic salts include: inorganic compound salts such as arsenite, arsenate, and arsenic trioxide; and organic complex salts, and examples of the antimony salts include: organic complex salts such as antimonyl tartrate; and inorganic compound salts such as antimony chlorides, antimony oxysulfate, and antimony trioxide.

Examples of the tellurium salts include: inorganic compound salts such as tellurite and tellurate; and organic complex salts, and examples of the bismuth salts include: inorganic compound salts such as bismuth(III) sulfate, bismuth(II) chloride, and bismuth(III) nitrate; and organic complex salts such as bismuth(I) oxalate.

One or more type of the heavy metal salts mentioned above can be used, and the total of the additive amounts thereof is preferably 1 ppm to 100 ppm, more preferably 1 ppm to 10 ppm, based on the total volume of the plating solution. If the additive amounts are smaller than 1 ppm, there is the case where the effect of improving deposition rates is not sufficient, and in the case of exceeding 100 ppm, the stability of the plating solution tends to get worse.

The non-electrolytic gold plating solution may contain a sulfur-based compound. By allowing the sulfur compound to be further contained in the non-electrolytic gold plating solution containing the phenyl compound-based reducing agent and the heavy metal salt, a sufficient deposition rate is obtained even at a temperature as low as a solution temperature on the order of 60° C. to 80° C., also the outer appearance of the film is favorable, and furthermore, the stability of the plating solution is particularly superior.

Examples of the sulfur-based compound include sulfide salts, thiocyanic acid salts, thiourea compounds, mercaptan compounds, sulfide compounds, disulfide compounds, thioketone compounds, thiazole compounds, and thiophene compounds.

Examples of the sulfide salts include potassium sulfide, sodium sulfide, sodium polysulfide, and potassium polysulfide; examples of the thiocyanic acid salts include sodium thiocyanate, potassium thiocyanate, and potassium dithiocyanate; and examples of the thiourea compounds include thiourea, methylthiourea, and dimethylthiourea.

Examples of the mercaptan compounds include 1,1-dimethylethanethiol, 1-methyl-octanethiol, dodecanethiol, 1,2-ethanedithiol, thiophenol, ortho-thiocresol, para-thiocresol, ortho-dimercaptobenzene, meta-dimercaptobenzene, para-dimercaptobenzene, thioglycol, thiodiglycol, thioglycolic acid, dithioglycolic acid, thiomalic acid, mercaptopropionic acid, 2-mercaptobenzimidazole, 2-mercapto-1-methylimidazole, and 2-mercapto-5-methylbenzimidazole.

Examples of the sulfide compounds include diethyl sulfide, diisopropyl sulfide, ethyl isopropyl sulfide, diphenyl sulfide, methylphenyl sulfide, rhodanine, thiodiglycolic acid, and thiodipropionic acid, and examples of the disulfide compounds include dimethyl disulfide, diethyl disulfide, and dipropyl disulfide.

Furthermore, examples of the thioketone compounds include thiosemicarbazide; examples of the thiazole compounds include thiazole, benzothiazole, 2-mercaptobenzothiazole, 6-ethoxy-2-mercaptobenzothiazole, 2-aminothiazole, 2,1,3-benzothiadiazole, 1,2,3-benzothiadiazole, (2-benzothiazolylthio)acetic acid, and 3-(2-benzothiazolylthio)propionic acid; and examples of the thiophene compounds include thiophene and benzothiophene.

Each of the sulfur-based compounds may be used alone, or two or more types may be used. The content of the sulfur-based compound is preferably 1 ppm to 500 ppm, more preferably 1 ppm to 30 ppm, particularly preferably 1 ppm to 10 ppm. In the case where the content of the sulfur-based compound is lower than 1 ppm, it is possible that: the deposition rate is reduced; poor throwing of plating occurs; and the outer appearance of the film gets worse. Alternatively, if the content of the sulfur-based compound exceeds 500 ppm, it is possible that: difficulty is found in concentration control; and the plating solution becomes unstable.

It is preferable that in addition to the aforementioned gold salt, reducing agent, heavy metal salt, and sulfur-based compound, at least one of a complexing agent, a pH buffering agent, and a metal ion masking agent should be contained in the non-electrolytic gold plating solution, and it is more preferable that all of these should be contained.

It is preferable that the complexing agent should be contained in the non-electrolytic gold plating solution according to the present embodiment. Examples specifically include non-cyanogen-based complexing agents such as sulfite, thiosulfate, and thiomalate. The content of the complexing agent is preferably 1 g/L to 200 g/L based on the total volume of the plating solution. In the case where the content of the complexing agent is lower than 1 g/L, gold-complexing power is reduced so that stability is reduced. If the content of the complexing agent exceeds 200 g/L, recrystallization occurs in the solution and is not economically preferable, though plating stability is improved. It is more preferable that the content of the complexing agent should be set to 20 g/L to 50 g/L.

It is preferable that the pH buffering agent should be contained in the non-electrolytic gold plating solution. The pH buffering agent has the effect of keeping the deposition rate at a fixed value and stabilizing the plating solution. A plurality of buffering agents may be mixed. Examples of the pH buffering agent include phosphate, acetate, carbonate, borate, citrate, and sulfate, and among these, borate or sulfate is particularly preferable.

It is preferable that the content of the pH buffering agent should be 1 g/L to 100 g/L based on the total volume of the plating solution. If the content of the pH buffering agent is lower than 1 g/L, the effect of buffering pH is absent, and if exceeding 100 g/L, recrystallization might occur. The more preferable content of the pH buffering agent is 20 g/L to 50 g/L.

It is preferable that the masking agent should be contained in the gold plating solution. A benzotriazole-based compound can be used as the masking agent, and examples of the benzotriazole-based compound include benzotriazole sodium, benzotriazole potassium, tetrahydrobenzotriazole, methylbenzotriazole, and nitrobenzotriazole.

It is preferable that the content of the metal ion masking agent should be 0.5 g/L to 100 g/L based on the total volume of the plating solution. If the content of the metal ion masking agent is lower than 0.5 g/L, there is the tendency that the effect of masking impurities is small and sufficient solution stability cannot be secured. On the other hand, if the content of the metal ion masking agent exceeds 100 g/L, there is the case where recrystallization occurs in the plating solution. A range of 2 g/L to 10 g/L is most preferable in light of costs and effects.

It is preferable that the pH of the gold plating solution should be in a range of 5 to 10. In the case where the pH of the plating solution is lower than 5, sulfite or thiosulfate which is the complexing agent in the plating solution might be decomposed so that toxic sulfur dioxide gas is generated. In the case where the pH exceeds 10, the stability of the plating solution tends to be reduced. For improving the deposition efficiency of the reducing agent and obtaining a fast deposition rate, it is preferable that the pH of the non-electrolytic gold plating solution should be in a range of 8 to 10.

As a method for the non-electrolytic plating, the filter that has finished the displacement gold plating is immersed to perform gold plating.

The solution temperature of the plating is preferably 50° C. to 95° C. If the solution temperature is lower than 50° C., it is possible that deposition efficiency is poor, and at higher than 95° C., the solution tends to be unstable.

It is preferable that the gold layer thus formed should be made of gold with a purity of 99 wt % or higher. If the gold purity of the gold layer is lower than 99 wt %, the cytotoxicity of a contact portion becomes high. From the viewpoint of enhancing reliability, it is more preferable that the purity of the gold layer should be 99.5 wt % or higher.

Moreover, it is preferable that the thickness of the gold layer should be set to 0.005 μm to 3 μmin, more preferably to 0.05 μm to 1 μm, further preferably to 0.1 μm to 0.5 μm. By setting the thickness of the gold layer to 0.005 μm or larger, the elution of the metal can be suppressed to some extent. On the other hand, even if the thickness of the gold layer exceeds 3 μm, effects are not further largely improved; thus it is preferable to be 3 μm or smaller, also from an economic standpoint.

The gold surface thus formed has no cytotoxicity and is stable in the atmosphere and in most of aqueous solutions containing blood. However, since the gold surface is relatively hydrophobic and low biocompatible, it is preferable to perform treatment to improve the biocompatibility. One example of the surface treatment will be shown below.

Leukocytes, erythrocytes, and platelets which are components in blood exhibit rejection to foreign substances. Thus, it is preferable to pretreat the metal surface. In this case, it is preferable to firmly adsorb a biocompatible polymer chemically.

Examples of the biocompatible polymer include vertebrate albumins and artificially synthesized polymers, with an artificially synthesized polymer being preferable in light of the preservative quality of the filter and lot-to-lot variation in polymer properties. In the case of using a vertebrate albumin, it is necessary to perform filter treatment immediately before blood treatment, and the operation is complicated. Particularly, in the case where blood cells are immobilized (in the case of being biologically dead), the artificially synthesized polymer is more preferable in terms of properties.

Examples of the artificially synthesized polymer include silicone, various polyurethanes, and polyphosphazene, with a homopolymer of 2-methacryloyloxyethylphosphorylcholine (abbreviation: MPC) or an MPC-containing copolymer being particularly superior. The structural formula is shown in the following chemical formula (1):

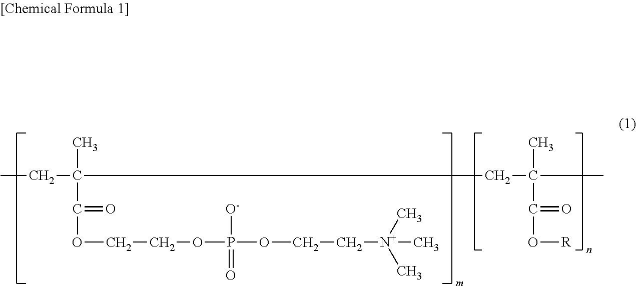

Example of commercially available MPC polymers include Biolipidure 103, Biolipidure 203, Biolipidure 206, Biolipidure 405, Biolipidure 502, Biolipidure 702, Biolipidure 802, Biolipidure 1002, Biolipidure 1201, and Biolipidure 1301.

Among others, the case where R is hydrogen or the case of containing an amino group is preferable because binding activity against the filter is improved. Specifically, when the biocompatible polymer contains an amino group or a carboxyl group, layer-by-layer assembly using electrostatic adsorption can be used, and furthermore, cytotoxicity is small.

Here, a method for forming, for example, a polymer having a carboxyl group or an amino group on the gold surface (the same holds true for palladium or platinum) will be shown.

The gold surface can be modified with a compound having any of a mercapto group, a sulfide group, and a disulfide group which form a coordinate bond with gold.

Examples specifically include 2-aminoethanethiol, ortho-fluorobenzenethiol, meta-hydroxybenzenethiol, 2-methoxybenzenethiol, 4-aminobenzenethiol, cysteamine, cysteine, dimethoxythiophenol, furfurylmercaptan, thioacetic acid, thiobenzoic acid, thiosalicylic acid, and dithiodipropionic acid.

Although a method for treating the gold surface with the compound described above is not particular limited, a compound such as mercaptoacetic acid is dispersed at approximately 10 mmol/L to approximately 100 mmol/L into an organic solvent such as methanol or ethanol, and conductive particles having the gold surface are dispersed therein.

Next, for enhancing a coverage ratio, it is desirable to perform covering with a polymer or the like. It is preferable that the polymer should employ electrostatic interaction for the covering. Such a method is called layer-by-layer assembly. The layer-by-layer assembly is a method for forming an organic thin film, which was published by G Decher et al. in 1992 (Thin Solid Films, 210/211, p. 831 (1992)). In this method, a base material is immersed alternately in aqueous solutions of a polymer electrolyte having a positive charge (polycation) and a polymer electrolyte having a negative charge (polyanion), whereby a set of the polycation and the polyanion adsorbed on the substrate through electrostatic attraction is laminated to obtain a composite film (layer-by-layer assembled film).

In the layer-by-layer assembly, the charge of the material formed on the base material and a material having the opposite charge in the solution are attracted through electrostatic attraction to thereby cause film growth; thus, when adsorption proceeds to neutralization of the charges, adsorption no longer occurs. Thus, once reaching some point of saturation, the film thickness is not further increased.

Such polymers include polyethylene glycol, etc., and 2-hydroxylethyl polymethacrylate, polyacrylic acid, polyethyleneimine, polyallylamine, and the like, and are not particularly limited. The polymer may be copolymerized with acrylic acid or methacrylic acid. From the viewpoint of charge density and costs, polyethyleneimine is preferable for the cation, and polyacrylic acid is preferable for the anion.

Although these polymers cannot be generalized depending on types, a molecular on the order of 500 to 1000000 is generally preferable, and a range of 5000 to 200000 is more preferable. In this context, the concentration of the polymer electrolyte in the solution is generally preferably on the order of 0.01 wt % to 10 wt/o. Moreover, the pH of the polymer electrolyte solution is not particularly limited.

Also, the coverage ratio can be controlled by adjusting the type, molecular weight, and concentration of the polymer electrolyte thin film. The concentration of the polymer is preferably in a range of 0.1% to 5.0%.

After thus covering with the cationic or anionic polymer, it is preferable to finally perform covering with a biocompatible polymer having a carboxyl group or an amino group.

When the filter surface has an amino group, it is preferable to perform covering with a biocompatible polymer having a carboxyl group. On the contrary, when the filter surface has a carboxyl group, it is preferable to perform covering with a biocompatible polymer having an amino group.

In the case of increasing the biocompatible polymer-adsorbed thickness, the biocompatible polymer having an amino group may be covered with the biocompatible polymer having a carboxyl group.

It is desirable that the thickness of the biocompatible polymer thus formed should be 20 angstroms or larger. The thickness of the biocompatible polymer can be controlled by treatment concentration or the number of treatment runs.

If the thickness of the biocompatible polymer is smaller than 20 angstroms, effects tend to be insufficient.

Although there is no particular upper limit of the thickness of the biocompatible polymer, more than 0.1 μm is not preferable because the pore diameter of the filter is affected and leukocytes are less likely to go through it.

The contact angle of water with the metal surface is decreased by the treatment with the biocompatible polymer. The contact angle can be measured with an apparatus that adheres to JIS R3265 “Wet-Related Test Method Conformity of the Board Glass Surface”. The contact angle is preferably 90 degrees or smaller, more preferably 60 degrees or smaller.

In general, the contact angle of pure water creates a wet state, albeit not complete, if falling below 90 degrees. When filtration is performed in a poorly wettable state, bubbles are generated, easily leading to a state where a portion of the filter is unavailable.

It is preferable that the biocompatible polymer should be put into a state where the metal surface is completely covered. Specifically, the lower ratio of the surface metal (Au, Pd, or Pt) as a result of evaluation by XPS (X-ray photoelectron spectroscopy) is more preferable, and it is desirable to be 10 at % (atomic ratio) or less, with 5 at % or less being more desirable. In the case where the ratio of the surface metal is high, the coverage ratio of the biocompatible polymer is low so that effects are reduced.

Strictly speaking, the results of measurement by XPS also differ depending on a measurement apparatus, etc. Exemplary XPS measurement is shown in Table 1.

TABLE 1

| | |
|---|---|
| Measurement | XPS (X-ray Photoelectron Spectroscopy) |
| apparatus name | apparatus |
| Manufacturer | Ulvac-Phi, Inc. |
| Product name | ESCA5400 model |
| Light source | Al-Kα (1486.7 eV) |
| Output | Output 400 W |
| Measurement area | 1.1 mm |
| Detection angle | 45° |
| Pass energy of | PE = 178.95 eV |
| qualitative spectrum | |
| Pass energy of | PE = 35.75 eV |
| quantitative spectrum | |

Alternatively, a method for treating the filter with an organism-derived polymer immediately before passing blood is also possible. Examples of the organism-derived polymer include vertebrate albumins.

Among others, serum albumin is desirable. The serum albumin is one of common proteins present in serum, and the molecular weight is approximately 66000. Although many proteins are present in serum, the serum albumin accounts for approximately 50% to approximately 65%.

The albumins have a large number of amino groups because a large number of amino acids are linked. The amino groups form a strong coordinate bond with the noble metal (gold, platinum, or palladium).

Particularly, gold forms a strong bond to the albumins even without performing special pretreatment, because few oxide films exist. In this context, bovine serum albumin among the albumins is inexpensive and thus preferable.

Particularly, fatty acid-free type serum albumin has the large effect of suppressing the adsorption of leukocytes, erythrocytes, and platelets.

The pretreatment of the filter is performed with a diluted solution of such a biocompatible polymer. The concentration of the biocompatible polymer is preferably in a range of 0.1% to 5.0%.

The solution is preferably water-based and may contain a buffer solution of phosphate or the like. Alternatively, a blood anticoagulant such as EDTA or heparin may be contained.

For the pretreatment of the filter with the diluted solution of the biocompatible polymer, the treatment time is preferably 1 minute or longer and 60 minutes or shorter, more preferably 1 minute or longer and 10 minutes or shorter. In the case of being shorter than 1 minute, the biocompatible polymer is less likely to strongly form a coordinate bond with the noble metal surface. On the other hand, the case of being longer than 60 minutes is not preferable from the viewpoint of an operation time.

Blood as a test solution is injected to the filter thus treated with the biocompatible polymer. Examples of blood collection tubes for the blood, i.e., blood collection tubes for supplying the blood to the test solution receptacle 10 of the cell-trapping system 100 include EDTA blood collection tubes in which cells are preserved alive, and immobilization-type blood collection tubes. The immobilization-type blood collection tubes include Cyto-Chex and Cell-Free-DNA (trade names, manufactured by Streck, Inc.), and the like.

The blood may be treated under negative pressure from below the filter 57, as with the cell-trapping system 100, may be treated under pressure from above the filter 57, or may be treated by centrifugal force, as with centrifugation. For any of the methods, it is important to control a linear velocity at which the blood passes through the through-holes 61 of the filter 57.

It is desirable that the linear velocity (Volume of the blood/Total area of the through-holes) at which the blood passes through the through-holes 61 of the filter 57 should be in a range of 0.5 cm/min to 100 cm/min, it is more desirable to be in a range of 1 cm/min to 40 cm/min, it is further preferable to be in a range of 4 cm/min to 40 cm/min, and it is most preferable to be in a range of 10 cm/min to 20 cm/min.

In the case where the linear velocity falls short of 1 cm/min, the remnants of leukocytes are increased because the leukocytes are less likely to be deformed. On the other hand, the case where the linear velocity exceeds 40 cm/min is not preferable because the rate of recovery of scarce cells tends to be decreased.

The amount of blood used is desirably in a range of 1 ml to 10 ml. The case where the amount of blood used falls short of 1 ml is not preferable because the number of cancer cells that can be recovered is decreased. The case where the amount of blood used exceeds 10 ml is not preferable because the amount of residual leukocytes is increased.

It is preferable to subsequently perform the washing of the filter 57 using a water-based washing solution. The washing solution preferably employs a solution containing EDTA or BSA in a phosphate buffer solution.

It is required that the amount of the washing solution should be used as an amount equal to or larger than the amount of the blood used. In the case where the amount of the blood is, for example, 3 ml, it is necessary to use 3 ml or more of the washing solution. The ideal amount of the washing solution is in a range of one time to three times the amount of the blood.

In this context, it is desirable that the area of an effective portion (region in which the through-holes 61 are present: region surrounded by the broken line 67 of FIG. 3) of the filter 57 should be in a range of 0.1 mm² or larger and 1 mm² or smaller. In the case where the area of an effective portion of the filter 57 falls short of 0.1 mm², observation becomes difficult because leukocytes per unit area are increased. The case where the area of an effective portion of the filter 57 exceeds 1 mm² is not desirable because the density of cancer cells per unit area is too low.

The scarce cells such as CTC can be enriched. The filter 57 can be chemically covered firmly with the biocompatible polymer to thereby exclude the components such as erythrocytes, leukocytes, and platelets.

### Example

### Filter 1

A photosensitive resin composition (PHOTEC RD-1225, thickness: 25 μm, manufactured by Hitachi Chemical Co., Ltd.) was laminated to one side of a substrate of 250 mm square (MCL-E679F: a substrate in which peelable copper foil was bonded to the MCL surface, manufactured by Hitachi Chemical Co., Ltd.). The lamination conditions involved a roll temperature of 90° C., a pressure of 0.3 MPa, and a conveyor speed of 2.0 m/min.

Next, a glass mask having a translucent portion with a rounded-corner rectangular shape and a size of 8.0×100 μm was placed on the photoresist lamination surface of the substrate. In the present Example, a glass mask in which rounded-corner rectangles oriented to the same direction were arranged at constant pitches in the major axis and minor axis directions was used. The area of an effective portion (region in which through-holes were disposed) of the filter was set to 0.36 mm² (0.6 mm×0.6 mm), and the aperture ratio of the effective portion was set to 6.7%. Subsequently, in vacuum of 600 mmHg or lower, the substrate with the glass mask placed thereon was irradiated from above with ultraviolet rays at a light exposure of 30 mJ/cm² using an ultraviolet irradiation apparatus.

Next, development was performed using a 1.0% aqueous sodium carbonate solution to form a resist layer in which a rectangular photoresist stood erect on the substrate. The exposed copper portion of this substrate with the resist was plated with a nickel plating solution (temperature: 55° C., approximately 20 min) pH-adjusted to 4.5 such that the thickness was approximately 16 μm. The composition of the nickel plating solution is shown in Table 2.

TABLE 2

| Composition of plating | Concentration |
|---|---|
| solution | (g/L) |
| Nickel sulfamate | 450 |
| Nickel chloride | 5 |
| Boric acid | 30 |

Next, the obtained nickel-plated layer was peeled off, together with the peelable copper foil on the substrate, and this peelable copper foil was removed by chemical dissolution using a chemical (MEC Bright SF-5420B, MEC Co., Ltd.) and involving stirring treatment at a temperature of 40° C. for approximately 120 minutes to thereby isolate a self-supported film (20 mm×20 mm) serving as a metal filter.

Finally, the photoresist remaining in the self-supported film was removed by resist peel-off (P3 Poleve, Henkel) using ultrasonic treatment at a temperature of 60° C. for approximately 40 minutes to prepare a metal filter having fine through-holes.

In this way, a metal filter having through-holes with sufficient accuracy was prepared without damages such as wrinkles, crimps, flaws, or curls.

Next, the metal filter was immersed in an acidic defatting solution Z-200 (trade name, manufactured by World Metal Co., Ltd.) to perform the removal of organic matter on the metal filter (40° C., 3 min).

After washing with water, displacement gold plating pretreatment was performed under conditions of 80° C. for 10 minutes using a solution of non-cyanogen-based non-electrolytic Au plating HGS-100 (trade name, manufactured by Hitachi Chemical Co., Ltd.) except for gold sulfite which was a gold supply source.

Next, displacement gold plating was performed by immersion in non-cyanogen-based displacement-type non-electrolytic Au plating HGS-100 (trade name, manufactured by Hitachi Chemical Co., Ltd.) at 80° C. for 20 minutes. The thickness of the displacement gold plating was 0.05 μm.

After washing with water, gold plating was performed by immersion in non-cyanogen-based reduction-type non-electrolytic Au plating HGS-5400 (trade name, manufactured by Hitachi Chemical Co., Ltd.) at 65° C. for 10 minutes, and after washing with water, drying was performed. The total thickness of the gold plating was 0.2 μm.

As a result of measuring the pore diameters of the through-holes under a microscope, the average minor pore diameter was 8.0 μm. One in which variation in the minor pore diameter fell within a range of 7.8 μm to 8.2 μm was regarded as a good-quality product. The difference between the pore diameters on the upper and lower sides was up to 0.2 μm. As a result of measuring the plating thickness using a contact-type film thickness meter Digimatic Thickness Gauge (trade name, manufactured by Mitutoyo Corp.), it was 16 μm. The details are as described in Table 3.

### Filter 2

A filter 2 was prepared under the same conditions as in the filter 1 except that the minor pore diameter was set to 7.2 μm. The details are as described in Table 3.

### Filter 3

A filter 3 was prepared under the same conditions as in the filter 1 except that the minor pore diameter was set to 7.6 μm. The details are as described in Table 3.

### Filter 4

A filter 4 was prepared under the same conditions as in the filter 1 except that the minor pore diameter was set to 8.4 μm. The details are as described in Table 3.

### Filter 5

A filter 5 was prepared under the same conditions as in the filter 1 except that the minor pore diameter was set to 8.8 μm. The details are as described in Table 3.

### Filter 6

A filter 6 was prepared under the same conditions as in the filter 1 except that the minor pore diameter was set to 9.2 μm. The details are as described in Table 3.

### Filter 7

A filter in which variation in pore diameter was ±0.4 μm as to the through-holes on the upper side of the filter was used. The basic production procedures conformed to the same conditions as in the filter 1 to prepare a filter 7. The details are as described in Table 3.

### Filter 8

The aperture ratio of the filter was set to 18.0%. The other basic production procedures conformed to the same conditions as in the filter 1 to prepare a filter 8. The details are as described in Table 3.

### Filter 9

The aperture ratio of the filter was set to 30.0%. The other basic production procedures conformed to the same conditions as in the filter 1 to prepare a filter 9. The details are as described in Table 3.

### Filter 10

The fine adjustment of the light exposure conditions was performed to prepare a filter in which the difference between the pore diameters of the through-holes on the upper and lower sides was 0.4 μm. The basic production procedures conformed to the same conditions as in the filter 1 to prepare a filter 10. The details are as described in Table 3.

### Filter 11

The major pore diameter of the filter was set to 80 μm. The other basic production procedures conformed to the same conditions as in the filter 1 to prepare a filter 11. The details are as described in Table 3.

### Filter 12

The major pore diameter of the filter was set to 60 μm. The other basic production procedures conformed to the same conditions as in the filter 1 to prepare a filter 12. The details are as described in Table 3.

### Filter 13

The major pore diameter of the filter was set to 30 μm. The other basic production procedures conformed to the same conditions as in the filter 1 to prepare a filter 13. The details are as described in Table 3.

### Filter 14

The plating conditions were changed, and the thickness of the plating was set to 10 μm. The other basic production procedures conformed to the same conditions as in the filter 1 to prepare a filter 14. The details are as described in Table 3.

### Filter 15

The plating conditions were changed, and the thickness of the plating was set to 12 μm. The other basic production procedures conformed to the same conditions as in the filter 1 to prepare a filter 15. The details are as described in Table 3.

### Filter 16

The plating conditions were changed, and the thickness of the plating was set to 14 μm. The other basic production procedures conformed to the same conditions as in the filter 1 to prepare a filter 16. The details are as described in Table 3.

### Filter 17

The plating conditions were changed, and the thickness of the plating was set to 18 μm. The other basic production procedures conformed to the same conditions as in the filter 1 to prepare a filter 17. The details are as described in Table 3.

### Filter 18

The plating conditions were changed, and the thickness of the plating was set to 20 μm. The other basic production procedures conformed to the same conditions as in the filter 1 to prepare a filter 18. The details are as described in Table 3.

### Filter 19

A filter 19 was prepared under the same conditions as in the filter 1 except that surface treatment was performed. The details are as described in Table 3. In this context, the surface treatment method is as shown below.

(Surface Treatment)

8 mmol of dithiodipropionic acid having carboxyl groups in the molecule was dissolved in 200 ml of methanol to prepare a reaction solution. Next, the metal filter after the gold plating was added to the reaction solution, reacted at room temperature for 2 hours, and then washed with methanol to prepare a filter having carboxyl groups on the surface.

The metal filter having carboxyl groups was immersed for 15 minutes in a 0.3 wt/o aqueous solution of polyethyleneimine having a large number of amino groups in the molecule and having a molecular weight of 70000, and washed to prepare a filter having amino groups on the surface.

The filter having amino groups on the surface was immersed for 15 minutes in a methanol solution containing 0.3 wt % of a copolymer BL405 (trade name, manufactured by NOF Corp.) of an MPC monomer and a carboxyl group-containing monomer, then washing was performed, and finally, treatment was performed at 80° C. for 30 minutes in a vacuum drier to thereby promote the dehydration condensation between the carboxyl groups and the amino groups and prepare a filter for biomaterial capturing in which the biocompatible polymer was chemically bonded firmly to the filter surface.

### Filter 20

A filter 20 was prepared under the same conditions as in the filter 2 except that the surface treatment was performed. The details are as described in Table 3.

### Filter 21

A filter 21 was prepared under the same conditions as in the filter 3 except that the surface treatment was performed. The details are as described in Table 3.

### Filter 22

A filter 22 was prepared under the same conditions as in the filter 4 except that the surface treatment was performed. The details are as described in Table 3.

### Filter 23

A filter 23 was prepared under the same conditions as in the filter 5 except that the surface treatment was performed. The details are as described in Table 3.

### Filter 24

A filter 24 was prepared under the same conditions as in the filter 6 except that the surface treatment was performed. The details are as described in Table 3.

### Experiments

### Preparation of Non-Small Cell Lung Cancer Cell Line

Non-small cell lung cancer cell line NCI-H358 cells were statically cultured under conditions of 37° C. and 5% CO₂ in an RPMI-1640 medium containing 10% fetal bovine serum (FBS). The cells were peeled off from the culture dish by trypsin treatment and thereby recovered, washed using a phosphate buffer solution (phosphate-buffered saline (PBS)), and then left standing at 37° C. for 30 minutes in 10 μM CellTracker Red CMTPX (Life Technologies Japan Ltd.) to thereby stain the NCI-H358 cells. Then, the cells were washed with PBS and left standing at 37° C. for 3 minutes in trypsin treatment to dissociate clumps of the cells. Then, the trypsin treatment was stopped using a medium, and the cells were washed with PBS and then suspended in PBS containing 2 mM EDTA and 0.5% bovine serum albumin (BSA) (hereinafter, referred to as 2 mM EDTA-0.5% BSA-PBS). In this context, PBS is phosphate-buffered saline, and product code 166-23555 manufactured by Wako Pure Chemical Industries, Ltd. was used. BSA manufactured by Sigma-Aldrich Corp. (product name: Albumin from bovine serum-Lyophilized powder, Bio Reagent for cell culture) was used. EDTA 2Na (ethylenediamine-N,N,N′,N′-tetraacetic acid disodium salt dihydrate) (product code 345-01865 manufactured by Wako Pure Chemical Industries, Ltd.) was used.

### Enrichment of CTC in Blood Sample

### Example 1

The experiment was conducted using a CTC recovery apparatus CT6000 (trade name, manufactured by Hitachi Chemical Co., Ltd.) in which the filter 1 was loaded in a cartridge. The CTC recovery apparatus had a passage for introducing a blood sample or a treatment solution (reagent), and the inlet port of the passage was connected to a reservoir prepared by processing a syringe. The blood sample and the treatment solution (reagent) were sequentially injected to this reservoir to thereby facilitate continuously performing operations such as CTC trap, staining, and washing. This CTC recovery apparatus corresponds to the cell-trapping system according to the present embodiment.

The blood sample was introduced to the CTC recovery apparatus to enrich cancer cells. A sample in which 1000 cancer cells per mL of blood were contained in the blood of a healthy individual collected into an EDTA-containing vacuum blood collection tube was used as the blood sample. The human non-small cell lung cancer cell line NCI-H358 described above was used as the cancer cells. In this context, the blood was used 6 hours after the blood collection.

1 ml of 2 mM EDTA-0.5% BSA-PBS (hereinafter, a washing solution) was introduced to the reservoir and thereby spread over the filter. Following this, solution sending was started at a flow rate of 400 μL/min using a peristaltic pump. Then, 1 ml of the blood was injected. Approximately 5 minutes later, 3 mL of 2 mM EDTA-0.5% BSA-PBS was introduced to the reservoir to perform the washing of the cells.

Next, a solution of 4% PFA dissolved in the washing solution was added to the cartridge, and the cells were immersed for 15 minutes.

After washing, a solution of 0.2% Triton X dissolved in the washing solution was added to the cartridge, and the cells were immersed for 15 minutes.

Further 10 minutes later, the pump flow rate was changed to 20 μL/min, and 600 μL of a cell-staining solution (Hoechst 33342: 30 μL, Wash Buffer: 300 mL) was introduced to the reservoir to fluorescently stain the cancer cells or leukocytes on the filter. Staining was performed for 30 minutes for the cells trapped on the filter, and then, 1 mL of 2 mM EDTA-0.5% BSA-PBS was introduced to the reservoir to perform the washing of the cells.

Subsequently, the filter was observed using a fluorescence microscope (BX61, manufactured by Olympus Corp.) equipped with a computer-controlled electric stage and a cooled digital camera (DP70, manufactured by Olympus Corp.) to count the numbers of the cancer cells and the leukocytes on the filter.

Images were captured using WU and WIG filters (manufactured by Olympus Corp.) in order to observe Hoechst 33342- and CellTracker Red CMTPX-derived fluorescence lights, respectively. Lumina Vision (manufactured by Mitani Corp.) was used in image capturing and analysis software. The results are shown in Table 4. Rate (%) of recovery of cells=The number of cancer cells recovered by the filter/The number of cancer cells mixed with the blood sample×100%. The number of leukocytes was calculated by subtracting the number of cancer cells from the number of cells stained with Hoechst 33342.

Detailed conditions regarding other evaluations are as shown in Table 3. In the table, the linear velocity was calculated by dividing the amount of liquid throughput per unit time by the opening area of the filter.

### Examples 2 to 23 and Comparative Examples 1 to 5

The experiment was conducted in the same way as in Example 1. The filter, the blood flow rate, the amount of the washing solution, the washing solution flow rate, and the type of the blood collection tube were appropriately changed. Detailed conditions are shown in Table 3.

(Results)

Example 1 is the standard Example of the present invention (EDTA blood collection tube, linear velocity of the solution: 16.58 cm/min, filter aperture ratio: 6.7%, minor pore diameter: 8.0 μm, major pore diameter: 100 μm, thickness: 16 μm, surface treatment: none). The residual leukocytes are as few as 601 cells, and the rate of recovery of cancer cells is also high. Comparative Example 1 is the case where the flow rate was increased and the linear velocity of the solution exceeded 40 cm/min. Although leukocytes are few, it is not good because the rate of recovery of cancer cells is reduced. Comparative Examples 2 to 5 changed the aperture ratio and the linear velocity and consequently changed the linear velocity of the solution. It is obvious that when the linear velocity falls below 10 cm/min, the residual leukocytes are increased. When the linear velocity falls below 2 cm/min, more than 4000 leukocytes remain and the rate of recovery of cancer cells falls short of 90%. By clogging, not only are leukocytes increased, but the rate of recovery of cancer cells is reduced because pressure rises locally. When the linear velocity falls below 1 cm/min, it was found to be not good because more than 7000 leukocytes remain and the rate of recovery of cancer cells is less than 80%.

Example 2 is the case where the amount of the washing solution was set to 1 mL. In this case, leukocytes tend to be slightly increased compared with Example 1, due to insufficient washing. It is obviously preferable to use a washing solution having the same volume or more as that of the introduced blood.

All of Examples 1 and 3 to 7 are the experiments using an EDTA blood collection tube, and only the minor pore diameter was changed. When the minor pore diameter is 7.6 μm to 8.4 μm, 10000 or less leukocytes remain and the rate of recovery of cancer cells attains 94% or more. In the case of using live cells, favorable results are obtained when the minor pore diameter is 7.6 μm to 8.4 μm, because the deformability of the cells is high. By contrast, all of Examples 18 to 23 employed a cell preservative-containing blood collection tube, and only the minor pore diameter was changed. In this case, when the minor pore diameter is 8.4 μm to 9.2 μm, 1300 or less leukocytes remain and the rate of recovery of cancer cells attains 90% or more. In the case of using preserved cells (dead cells), favorable results are obtained when the minor pore diameter is 8.4 μm to 9.2 μm, because the deformability of the cells is low. Specifically, the optimum minor pore diameter differs depending on the life or death of the cells.

Example 8 is the case using the filter in which variation in the pore diameters of the through-holes on the upper side of the filter was ±0.4 μm. When compared to Example 1 having the same average, the leukocytes are increased and the rate of recovery of cancer cells is reduced. It is obviously important to suppress the variation in pore diameter on the upper side to ±0.2 μm. Example 9 is the case using the filter in which the difference between the pore diameters on the upper and lower sides was 0.4 μm. In this case, the leukocytes tend to be increased compared with Example 1.

Examples 1 and 10 to 12 are the cases where only the major pore diameter of the through-holes was changed. As the major pore diameter gets longer, the leukocytes are decreased but the rate of recovery of cancer cells rarely varies. This seems to be effects by which fibrous foreign substances such as fibrin were able to be removed by increasing the major pore diameter.

Examples 1 and 13 to 17 are the cases where the thickness of the filter was changed to 10 μm to 20 μm. In the case where the thickness of the filter is 10 μm, the rate of recovery of cancer cells is less than 90%. On the other hand, in the case where the thickness of the filter is 20 μm, residual leukocytes exceed 2000 cells. It is necessary to control the filter thickness in a range of 10 μm to 20 μm.

TABLE 3

| | | | | | Variation | Difference | | |
|---|---|---|---|---|---|---|---|---|
| | | | | | in pore | between pore | | |
| | | | Minor | Major | diameter | diameters on | | |
| | | Aperture | pore | pore | on upper | upper side and | | Surface |
| | Filter | ratio | diameter | diameter | side | on lower side | Thickness | treatment |
| Example 1 | Filter 1 | 6.7% | 8.0 μm | 100 μm | ±0.2 μm | 0.2 μm | 16 μm | None |
| Comparative | Filter 1 | 6.7% | 8.0 μm | 100 μm | ±0.2 μm | 0.2 μm | 16 μm | None |
| Example 1 | | | | | | | | |
| Example 2 | Filter 1 | 6.7% | 8.0 μm | 100 μm | ±0.2 μm | 0.2 μm | 16 μm | None |
| Example 3 | Filter 2 | 6.7% | 7.2 μm | 100 μm | ±0.2 μm | 0.2 μm | 16 μm | None |
| Example 4 | Filter 3 | 6.7% | 7.6 μm | 100 μm | ±0.2 μm | 0.2 μm | 16 μm | None |
| Example 5 | Filter 4 | 6.7% | 8.4 μm | 100 μm | ±0.2 μm | 0.2 μm | 16 μm | None |
| Example 6 | Filter 5 | 6.7% | 8.8 μm | 100 μm | ±0.2 μm | 0.2 μm | 16 μm | None |
| Example 7 | Filter 6 | 6.7% | 9.2 μm | 100 μm | ±0.2 μm | 0.2 μm | 16 μm | None |
| Example 8 | Filter 7 | 6.7% | 8.0 μm | 100 μm | ±0.4 μm | 0.2 μm | 16 μm | None |
| Comparative | Filter 8 | 18.0% | 8.0 μm | 100 μm | ±0.2 μm | 0.2 μm | 16 μm | None |
| Example 2 | | | | | | | | |
| Comparative | Filter 9 | 30.0% | 8.0 μm | 100 μm | ±0.2 μm | 0.2 μm | 16 μm | None |
| Example 3 | | | | | | | | |
| Example 9 | Filter 10 | 6.7% | 8.0 μm | 100 μm | ±0.2 μm | 0.4 μm | 16 μm | None |
| Example 10 | Filter 11 | 6.7% | 8.0 μm | 80 μm | ±0.2 μm | 0.2 μm | 16 μm | None |
| Example 11 | Filter 12 | 6.7% | 8.0 μm | 60 μm | ±0.2 μm | 0.2 μm | 16 μm | None |
| Example 12 | Filter 13 | 6.7% | 8.0 μm | 30 μm | ±0.2 μm | 0.2 μm | 16 μm | None |
| Example 13 | Filter 14 | 6.7% | 8.0 μm | 100 μm | ±0.2 μm | 0.2 μm | 10 μm | None |
| Example 14 | Filter 15 | 6.7% | 8.0 μm | 100 μm | ±0.2 μm | 0.2 μm | 12 μm | None |
| Example 15 | Filter 16 | 6.7% | 8.0 μm | 100 μm | ±0.2 μm | 0.2 μm | 14 μm | None |
| Example 16 | Filter 17 | 6.7% | 8.0 μm | 100 μm | ±0.2 μm | 0.2 μm | 18 μm | None |
| Example 17 | Filter 18 | 6.7% | 8.0 μm | 100 μm | ±0.2 μm | 0.2 μm | 20 μm | None |
| Example 18 | Filter 19 | 6.7% | 8.0 μm | 100 μm | ±0.2 μm | 0.2 μm | 16 μm | Treated |
| Example 19 | Filter 20 | 6.7% | 7.2 μm | 100 μm | ±0.2 μm | 0.2 μm | 16 μm | Treated |
| Example 20 | Filter 21 | 6.7% | 7.6 μm | 100 μm | ±0.2 μm | 0.2 μm | 16 μm | Treated |
| Example 21 | Filter 22 | 6.7% | 8.4 μm | 100 μm | ±0.2 μm | 0.2 μm | 16 μm | Treated |
| Example 22 | Filter 23 | 6.7% | 8.8 μm | 100 μm | ±0.2 μm | 0.2 μm | 16 μm | Treated |
| Example 23 | Filter 24 | 6.7% | 9.2 μm | 100 μm | ±0.2 μm | 0.2 μm | 16 μm | Treated |
| Comparative | Filter 9 | 30.0% | 8.0 μm | 100 μm | ±0.2 μm | 0.2 μm | 16 μm | None |
| Example 4 | | | | | | | | |
| Comparative | Filter 9 | 30.0% | 8.0 μm | 100 μm | ±0.2 μm | 0.2 μm | 16 μm | None |
| Example 5 | | | | | | | | |

TABLE 4

| | | | | | | Blood | Leukocyte | NIC-H358 |
|---|---|---|---|---|---|---|---|---|
| | Blood (fixed to 1 ml) | | Washing solution | | | collection | Remaining | Rate of |
| | Flow rate | Linear velocity | Flow rate | Linear velocity | Amount | tube | amount | recovery |
| Example 1 | 400 μl/min | 16.58 cm/min | 400 μl/min | 16.58 cm/min | 3 ml | EDTA | 601 cells | 95.8(%) |
| Comparative | 1000 μl/min | 41.45 cm/min | 400 μl/min | 41.45 cm/min | 3 ml | EDTA | 321 cells | 77.5(%) |
| Example 1 | | | | | | | | |
| Example 2 | 400 μl/min | 16.58 cm/min | 400 μl/min | 16.58 cm/min | 1 ml | EDTA | 1580 cells | 97.2(%) |
| Example 3 | 400 μl/min | 16.58 cm/min | 400 μl/min | 16.58 cm/min | 3 ml | EDTA | 1840 cells | 98.3(%) |
| Example 4 | 400 μl/min | 16.58 cm/min | 400 μl/min | 16.58 cm/min | 3 ml | EDTA | 823 cells | 97.5(%) |
| Example 5 | 400 μl/min | 16.58 cm/min | 400 μl/min | 16.58 cm/min | 3 ml | EDTA | 598 cells | 94.1(%) |
| Example 6 | 400 μl/min | 16.58 cm/min | 400 μl/min | 16.58 cm/min | 3 ml | EDTA | 588 cells | 89.3(%) |
| Example 7 | 400 μl/min | 16.58 cm/min | 400 μl/min | 16.58 cm/min | 3 ml | EDTA | 589 cells | 87.5(%) |
| Example 8 | 400 μl/min | 16.58 cm/min | 400 μl/min | 16.58 cm/min | 3 ml | EDTA | 889 cells | 92.4(%) |
| Comparative | 400 μl/min | 6.17 cm/min | 400 μl/min | 6.17 cm/min | 3 ml | EDTA | 1543 cells | 96.3(%) |
| Example 2 | | | | | | | | |
| Comparative | 400 μl/min | 3.70 cm/min | 400 μl/min | 3.70 cm/min | 3 ml | EDTA | 2454 cells | 92.5(%) |
| Example 3 | | | | | | | | |
| Example 9 | 400 μl/min | 16.58 cm/min | 400 μl/min | 16.58 cm/min | 3 ml | EDTA | 1125 cells | 96.3(%) |
| Example 10 | 400 μl/min | 16.58 cm/min | 400 μl/min | 16.58 cm/min | 3 ml | EDTA | 754 cells | 95.7(%) |
| Example 11 | 400 μl/min | 16.58 cm/min | 400 μl/min | 16.58 cm/min | 3 ml | EDTA | 834 cells | 96.5(%) |
| Example 12 | 400 μl/min | 16.58 cm/min | 400 μl/min | 16.58 cm/mm | 3 ml | EDTA | 1120 cells | 97.1(%) |
| Example 13 | 400 μl/min | 16.58 cm/min | 400 μl/min | 16.58 cm/min | 3 ml | EDTA | 543 cells | 88.9(%) |
| Example 14 | 400 μl/min | 16.58 cm/min | 400 μl/min | 16.58 cm/min | 3 ml | EDTA | 678 cells | 94.3(%) |
| Example 15 | 400 μl/min | 16.58 cm/min | 400 μl/min | 16.58 cm/min | 3 ml | EDTA | 672 cells | 95.1(%) |
| Example 16 | 400 μl/min | 16.58 cm/min | 400 μl/min | 16.58 cm/min | 3 ml | EDTA | 1125 cells | 96.2(%) |
| Example 17 | 400 μl/min | 16.58 cm/min | 400 μl/min | 16.58 cm/min | 3 ml | EDTA | 2834 cells | 89.3(%) |
| Example 18 | 400 μl/min | 16.58 cm/min | 400 μl/min | 16.58 cm/min | 3 ml | CFD*² | 2345 cells | 94.8(%) |
| Example 19 | 400 μl/min | 16.58 cm/min | 400 μl/min | 16.58 cm/min | 3 ml | CFD*² | 7267 cells | 78.9(%) |
| Example 20 | 400 μl/min | 16.58 cm/min | 400 μl/min | 16.58 cm/min | 3 ml | CFD*² | 4326 cells | 83.8(%) |
| Example 21 | 400 μl/min | 16.58 cm/min | 400 μl/min | 16.58 cm/min | 3 ml | CFD*² | 1234 cells | 97.1(%) |
| Example 22 | 400 μl/min | 16.58 cm/min | 400 μl/min | 16.58 cm/min | 3 ml | CFD*² | 987 cells | 94.1(%) |
| Example 23 | 400 μl/min | 16.58 cm/min | 400 μl/min | 16.58 cm/min | 3 ml | CFD*² | 876 cells | 90.0(%) |
| Comparative | 200 μl/min | 1.85 cm/mm | 400 μl/min | 1.85 cm/min | 3 ml | EDTA | 4230 cells | 88.6(%) |
| Example 4 | | | | | | | | |
| Comparative | 100 μl/min | 0.93 cm/min | 100 μl/min | 0.93 cm/min | 3 ml | EDTA | 7689 cells | 75.1(%) |
| Example 5 | | | | | | | | |

As mentioned above, cancer cells in blood can be trapped with relatively high efficiency by using the present invention.

What is claimed is:

1. A cell-trapping system which traps specific cells in blood by passing the blood from a first principal surface side of a filter with a plurality of through-holes formed across a thickness of a sheet toward a second principal surface side opposed to the first principal surface, wherein
a linear velocity of the blood at a point in time when the blood passes through the filter is 1 cm/min to 40 cm/min,
an aperture ratio of the filter is 3% to 10%,
the plurality of through-holes disposed in the filter each have a rectangular shape or a rounded-corner rectangular shape, and
a mean of minor pore diameters of the plurality of through-holes on the first principal surface side of the filter is 7.0 μm to 10.0 μm.

2. The cell-trapping system according to claim 1, wherein a fluctuation range of the minor pore diameters of the plurality of through-holes on the first principal surface side of the filter is a mean±0.2 μm.

3. The cell-trapping system according to claim 1, wherein a mean of major pore diameters of the plurality of through-holes on the first principal surface side is 80 μm or larger.

4. The cell-trapping system according to claim 1, wherein a difference between the mean of minor pore diameters of the plurality of through-holes on the first principal surface side of the filter and a mean of minor pore diameters of the plurality of through-holes on the second principal surface side is 0.2 μm or less.

5. The cell-trapping system according to claim 1, wherein a thickness of the filter is 10 μm or larger and 20 μm or smaller.

6. The cell-trapping system according to claim 1, wherein preservation of the blood is performed using an EDTA-containing blood collection tube in a state where at least some of the cells are alive, and the blood is injected to the cell-trapping system within 24 hours after blood collection.

7. The cell-trapping system according to claim 6, wherein the mean of minor pore diameters of the plurality of through-holes on the first principal surface side of the filter is in a range of 7.6 μm to 8.4 μm.

8. The cell-trapping system according to claim 1, wherein
preservation of the blood is performed using a cell preservative-containing blood collection tube in a state where the cells have been killed, and the blood is injected to the cell-trapping system within 96 hours after blood collection.

9. The cell-trapping system according to claim 8, wherein the mean of minor pore diameters of the plurality of through-holes on the first principal surface side of the filter is in a range of 8.4 μm to 9.2 μm.

10. The cell-trapping system according to claim 1, wherein an amount of the blood injected is in a range of 1 mL to 10 mL.

11. The cell-trapping system according to claim 1, wherein the cell-trapping system has a step of injecting a washing solution having a volume equal to or more than that of the injected blood after the blood injection to wash the filter.

12. The cell-trapping system according to claim 11, wherein a linear velocity at which the washing solution passes through the through-holes of the filter is in a range of 1 cm/min to 40 cm/min.

13. The cell-trapping system according to claim 1, wherein a main component of the filter is a metal.

14. The cell-trapping system according to claim 13, wherein a surface of the filter is gold, platinum, or palladium, or an alloy thereof.

15. The cell-trapping system according to claim 13, wherein the filter has any of nickel, copper, and palladium, or an alloy thereof as the main component.

16. The cell-trapping system according to claim 1, wherein a biocompatible polymer is firmly adsorbed on the filter.

17. The cell-trapping system according to claim 1, wherein an area of an effective portion of the filter is in a range of 0.1 mm² or larger and 1 mm² or smaller.

18. The cell-trapping system according to claim 1, wherein the specific cells in blood are cancer cells in blood.
